(19) United States
(12) Patent Application Publication
(10) Pub. No.: US 2012/0228066 A1
(43) Pub. Date: Sep. 13, 2012

(54) ELEVATOR GROUP CONTROL SYSTEM

(75) Inventors: Masayuki Mitsuda, Aichi (JP); Yuji Fujihata, Tokyo (JP); Naohiko Suzuki, Tokyo (JP); Sakurako Tokura, Tokyo (JP); Yoshimasa Koba, Tokyo (JP); Hidenobu Nakashima, Aichi (JP); Masaharu Eto, Aichi (JP); Yoshinori Nonami, Aichi (JP)

(73) Assignee: Mitsubishi Electric Corporation, Tokyo (JP)

(21) Appl. No.: 13/510,326

(22) PCT Filed: Jan. 20, 2010
(86) PCT No.: PCT/JP2010/050635

§ 371 Date: May 17, 2012

(51) Int. Cl. B66B 1/20

(52) U.S. Cl. 187/389

(57) ABSTRACT

A group control system includes a destination operating panel by use of which a user registers a destination floor by manual operation before boarding an elevator car and an authentication device by use of which a user performs personal authentication by inputting personal identification information. The destination floor registration from the destination operating panel is prohibited with respect to prescribed prohibited floors and when personal authentication has been carried out by the authentication device, the prohibition of destination floor registration with respect to prohibited floors is canceled. The group controller assigns an optimum car from a plurality of elevators to the destination floor registered from the destination operating panel. In the elevator group control system, it becomes possible for a user to register his or her destination floor before boarding an elevator car without lowering the level of security of the system.

### TECHNICAL FIELD

The present invention relates to an elevator group control system which performs the operation control of a plurality of elevators.

### BACKGROUND ART

In a group control system which performs the operation control of a plurality of elevators, an optimum elevator (the car of an elevator) is assigned from the above-described plurality of elevators to a destination floor registered by a user, thereby causing a respond to be made.

As a conventional technique of a group control system having such a function there has been proposed, for example, a group control system in which an authentication device is installed in an elevator hall, whereby the above-described authentication device reads information from an information transmitter carried by a user and automatically performs the destination floor registration of the user (refer to Patent Literature 1).

### CITATION LIST

### Patent Literature

Patent Literature 1: Japanese Patent Laid-Open No. 8-81143

### SUMMARY OF INVENTION

### Technical Problem

In the group control system described in Patent Literature 1, the authentication device on the system side automatically performs communication with the information transmitter and, therefore, there is a possibility that destination floor registration is performed without the intention of a user. For this reason, this group control system has the problem that the level of security as a system decreases.

The present invention was made in order to solve the problem described above, and an object of the invention is to provide an elevator group control system which performs the operation control of a plurality of elevators and which enables a user to register his or her destination floor before boarding an elevator car without lowering the level of security of the system.

### Solution to Problem

An elevator group control system of the invention is an elevator group control system which performs operation control of a plurality of elevators. The elevator control system comprises a destination operating panel by use of which a user registers a destination floor by manual operation before boarding an elevator car, an authentication device which is provided in proximity to the destination operating panel and by use of which a user performs personal authentication by inputting personal identification information, registration floor determination means which prohibits destination floor registration from the destination operating panel with respect to a prescribed prohibited floor, and cancels prohibition of destination floor registration with respect to the prohibited floor upon personal authentication by the authentication device, and a group controller which assigns an optimum car from the plurality of elevators to a destination floor registered from the destination operating panel.

### Advantageous Effect of Invention

According to the present invention, in an elevator group control system which performs the operation control of a plurality of elevators, it becomes possible for a user to register his or her destination floor before boarding an elevator car without lowering the level of security of the system.

### BRIEF DESCRIPTION OF DRAWINGS

FIG. 1 is a block diagram showing an elevator group control system of the present invention.

FIG. 2 is a flowchart showing the actions of the elevator group control system in the first embodiment of the present invention.

FIG. 3 is a flowchart showing other actions of the elevator group control system in the first embodiment of the present invention.

FIG. 4 is a flowchart showing other actions of the elevator group control system in the first embodiment of the present invention.

FIG. 5 is a flowchart showing the actions of the elevator group control system in the second embodiment of the present invention.

### DESCRIPTION OF EMBODIMENTS

The present invention will be described in more detail with reference to the accompanying drawings. Incidentally, in each of the drawings, like numerals refer to like or similar parts and redundant descriptions of these parts are appropriately simplified or omitted.

### First Embodiment

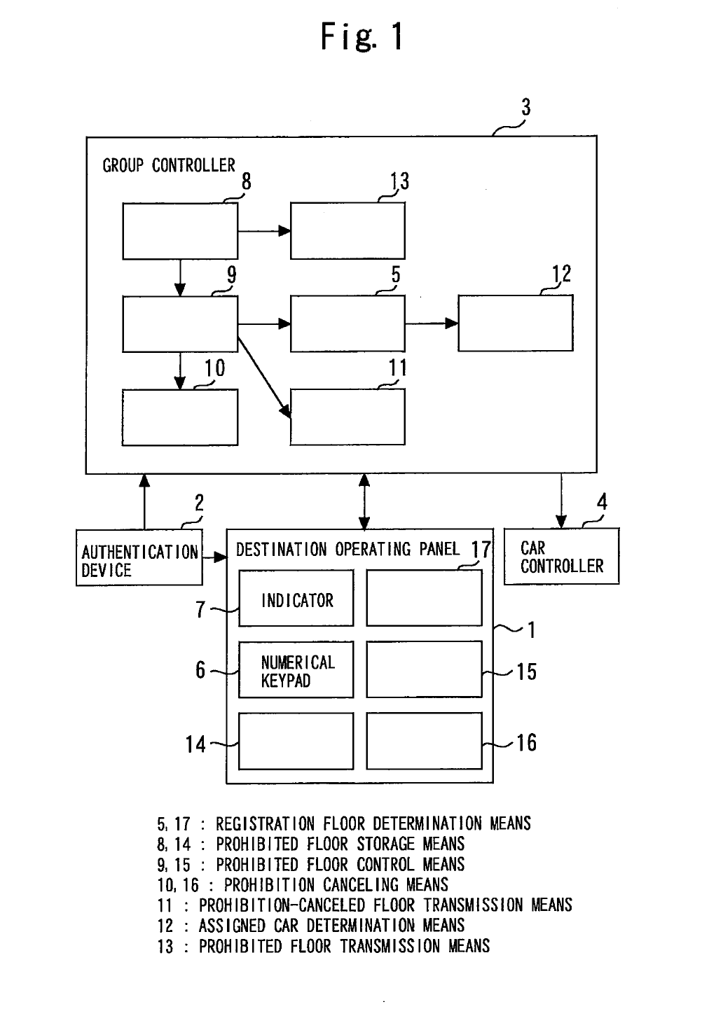

FIG. 1 is a block diagram showing an elevator group control system of the present invention. This group control system has the function of performing the operation control of a plurality of elevators.

In FIG. 1, reference numeral 1 denotes a destination operating panel by use of which an elevator user registers a destination floor by manual operation. The destination operating panel 1 is installed in an elevator hall and the like, and a user manually inputs his or her destination floor from the destination operating panel 1 before boarding an elevator (the car of an elevator).

Reference numeral 2 denotes an authentication device by use of which an elevator user performs personal authentication by inputting information for identifying individuals (hereinafter referred to as “personal identification information”). The authentication device 2 makes a comparison between the inputted personal identification information (for example, card information, fingerprint information and personal identification number or the like) and the pre-registered information and makes a determination as to whether or not the person who inputted the personal identification information is a pre-registered person. After performing the authenticating carried out by the above-described comparison that the person who has inputted the personal identification information is the pre-registered person himself or herself, the authentication device 2 outputs information to that effect (a successful authentication signal). The authentication device 2 corresponds to each destination operating panel 1 and is provided, for example, in proximity to the corresponding destination operating panel 1.

Reference numeral 3 denotes a group controller which performs the operation control of a plurality of elevators and reference numeral 4 denotes a car controller which controls the car of each elevator.

The group controller 3 has the function of assigning an optimum car of an elevator from the above-described plurality of elevators to a destination floor registered by a user by operating the destination operating panel 1. Upon receipt of assignment information from the group controller 3, the car controller 4 causes the car of own elevator to respond to the destination floor registered by the user from the destination operating panel 1 on the basis of the received assignment information.

The group control system having the above-described configuration has the function of preventing a decrease in the level of security. The registration floor determination means is provided in order to realize the above-described function and in normal times prohibits the destination floor registration from the destination operating panel 1 with respect to a prescribed prohibited floor. When personal authentication has been carried out by the authentication device 2, the registration floor determination means cancels the prohibition of destination floor registration with respect to the above-described prohibited floor and permits the prohibited floor to be registered as a destination floor. Incidentally, for a destination floor on which the registration prohibition by the registration floor determination means has not been imposed, as in normal times, the registration is carried out on the basis of the operation of a user by use of the destination operating panel 1.

All that is required is that the registration floor determination means be provided in either the group controller 3 or the destination operating panel 1. In this embodiment, a concrete description will be given of the case where the registration floor determination means 5 is provided in the group controller 3.

In this case, a numerical keypad 6 and an indicator 7 are provided in the destination operating panel 1. The numerical keypad 6 is a device by use of which a user manually inputs his or her destination floor before boarding an elevator car, and is permanently installed on the destination operating panel 1. Incidentally, the numerical keypad 6 may be made up of other input means such as buttons for destination floors. The indicator 7 is provided in order to provide prescribed information to a user who registers a destination floor from the destination operating panel 1.

On the other hand, the group controller 3 is provided with prohibited floor storage means 8, prohibited floor control means 9, prohibition canceling means 10, prohibition-canceled floor transmission means 11 and assigned car determination means 12 in addition to the above-described registration floor determination means 5.

The prohibited floor storage means 8 has the function of storing prohibited floors. A prohibited floor refers to a floor for limiting destination floor registration from the destination operating panel 1 only to a user whose personal authentication has been carried out by the authentication device 2. For example, part of the floors at which the cars of the above-described plurality of elevators stop are stored beforehand as prohibited floors in the prohibited floor storage means 8.

The prohibited floor control means 9 has the function of determining a prohibited floor for which the prohibition of destination floor registration is to be canceled (a prohibition-canceled floor). When personal authentication has been carried out by the authentication device 2, a successful authentication signal is transmitted from the authentication device 2 to the group controller 3. Upon receipt of the successful authentication signal by the group controller 3 from the authentication device 2, the prohibition canceling means 10 outputs a request for prohibition cancel to the prohibited floor control means 9. Upon input of the request for prohibition cancel from the prohibition canceling means 10, the prohibited floor control means 9 determines the above-described prohibition-canceled floor on the basis of the prohibited floors stored in the prohibited floor storage means 8. After performing the above-described determination, the prohibited floor control means 9 outputs prohibition-canceled floor information to the prohibition-canceled floor transmission means 11 and the registration floor determination means 5.

The prohibition-canceled floor transmission means 11 has the function of transmitting prohibition-canceled floor information inputted from the prohibited floor control means 9 to the destination operating panel 1. Incidentally, upon receipt of the prohibition-canceled floor information from the prohibition-canceled floor transmission means 11, the destination operating panel 1 indicates prescribed information on the indicator 7, thereby notifying a user. For example, upon receipt of the prohibition-canceled floor information, the destination operating panel 1 indicates a list of prohibition-canceled floors on the indicator 7 and notifies a user of information to the effect that the destination floor registration of each prohibition-canceled floor is possible. Or upon receipt of the prohibition-canceled floor information, the destination operating panel 1 does not cause the indicator 7 to indicate the floor name of a concrete prohibition-canceled floor and indicates on the indicator 7 information only to the effect that the prohibition of destination floor registration with respect to prohibited floors has been canceled.

When a user manually inputs a destination floor by operating the numerical keypad 6 while, for example, making sure of the indication of the indicator 7, the information on the inputted destination floor is transmitted from the destination operating panel 1 to the group controller 3.

The registration floor determination means 5 has the function of determining whether or not the destination floor of the user is to be registered on the basis of the prohibition-canceled floor information from the prohibited floor control means 9 and the destination floor information from the destination operating panel 1.

For example, the registration floor determination means 5 makes a determination as to whether or not the destination floor inputted from the numerical keypad 6 has been stored as a prohibited floor in the prohibited floor storage means 8. In the case where the inputted destination floor has been stored as a prohibited floor, the registration floor determination means 5 permits the registration only when personal authentication has been carried out by the authentication device 2. In the case where the inputted destination floor has not been stored as a prohibited floor, the registration floor determination means 5 permits the registration if the destination floor is capable of being served.

The assigned car determination means 12 has the function of assigning a car to the destination floor that is inputted by a user from the numerical keypad 6 and whose registration has been permitted by the registration floor determination means 5. After determination of an assigned car to a destination floor, the assigned car determination means 12 transmits assignment information to a corresponding car controller 4 and causes the corresponding car controller 4 to make a response to the destination floor. Furthermore, after determination of an assigned car to a destination floor, the assigned car determination means 12 transmits assignment information to a corresponding destination operating panel 1 and causes the indicator 7 to indicate the information on the assigned car.

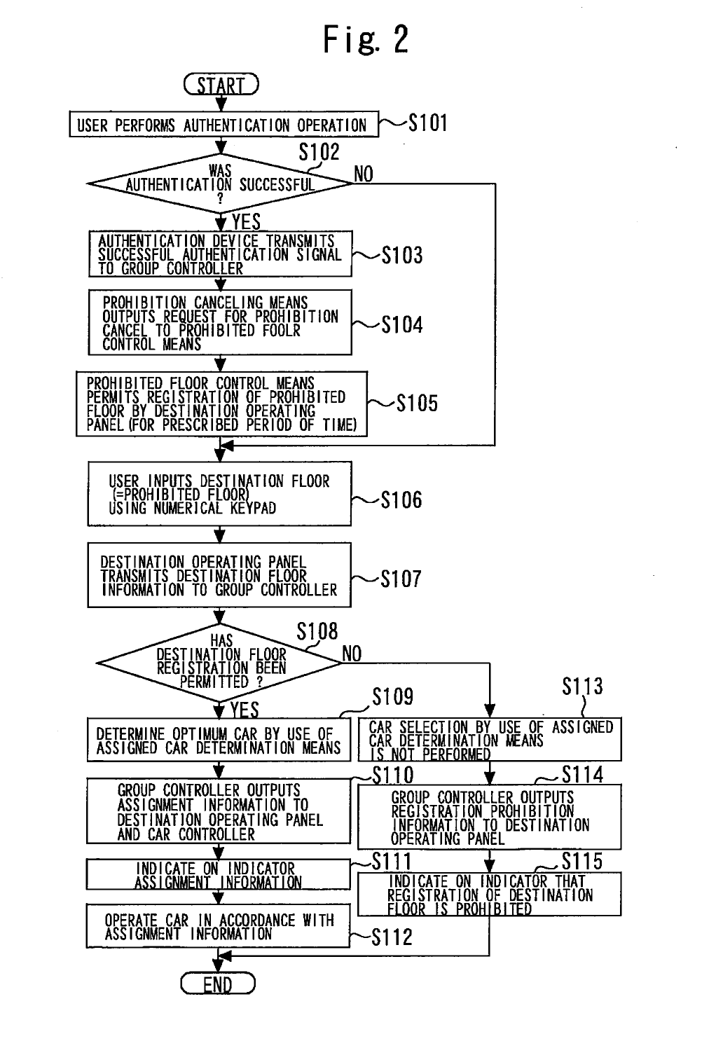

Next, referring to FIG. 2, a concrete description will be given of the actions of the group control system having the above-described configuration. FIG. 2 is a flowchart showing the actions of the elevator group control system in the fist embodiment of the present invention.

When an elevator user performs an authentication operation on the authentication device 2 (S101), the authentication device 2 performs personal authentication processing on the basis of inputted personal identification information and makes a determination as to whether or not the authentication was successful (S102). If personal authentication is carried out in S102, the authentication device 2 transmits a successful authentication signal to the group controller 3 (S103).

In the group controller 3, upon receipt of the successful authentication signal from the authentication device 2, a request for prohibition cancel is outputted from the prohibition canceling means 10 to the prohibited floor control means 9 (S104). Upon input of the request for prohibition cancel from the prohibition canceling means 10, the prohibited floor control means 9 performs processing for permitting registering a prohibited floor as a destination floor for a prescribed period of time from a destination operating panel 1 corresponding to the authentication device 2 in which personal authentication has been carried out (S105). That is, the prohibited floor control means 9 outputs prohibition-canceled floor information to the registration floor determination means 5.

Incidentally, when the user performs the input of a destination floor using the numerical keypad 6 of the destination operating panel 1 (S106), destination floor information is transmitted from the destination operating panel 1 to the group controller 3 (S107). Upon receipt of the destination floor information from the destination operating panel 1, the registration floor determination means 5 makes a determination as to whether or not the registration of the destination floor has been permitted (S108). In the case where in S106 the user inputted a floor which is stored as a prohibited floor in the prohibited floor storage means 8 as a destination floor, the registration floor determination means 5 determines in S108 that the registration has been permitted only in the case where prohibition-canceled floor information was inputted in S105.

In this case, the assigned car determination means 12 assigns an optimum car to the destination floor of the user (S109). When an assigned car to the destination floor of the user has been determined, the group controller 3 transmits assigned information to the destination operating panel 1 by use of which the user performed destination floor input in S106 and a corresponding car controller 4 (S110).

Upon receipt of the assignment information from the group controller 3, the destination operating panel 1 causes the indicator 7 to indicate the information on the assigned car and notifies the user (S111). The car controller 4 appropriately controls the car on the basis of the assignment information received from the group controller 3 (S112).

On the other hand, in the case where in S102 the personal authentication was unsuccessful or in S101 no authentication operation was performed on the authentication device 2, when in S106 the user inputs the floor stored as a prohibited floor in the prohibited floor storage means 8 as a destination floor, in S108 a determination is made to the effect that the registration of the floor has not been permitted. In this case, the assigned car determination means 12 does not perform car assignment to the destination floor of the user (S113). The group controller 3 transmits registration prohibition information to the destination operating panel 1 by use of which the user performed destination floor input in S106 (S114). Incidentally, upon receipt of the registration prohibition information from the group controller 3, the destination operating panel 1 causes the indicator 7 to indicate information to the effect that the registration of the destination floor inputted by the user is prohibited and that this floor cannot be registered (S115).

According to the first embodiment of the present invention, when personal authentication has been performed by the authentication device 2, in a destination operating panel 1 paired with the authentication device 2, it becomes possible to perform an operation for registering a prohibited floor as a destination floor. For this reason, in the group control system in which a user registers a destination floor before boarding an elevator car, there is no danger of lowering the level of security of the system, nor is there danger of impairing the convenience of the system.

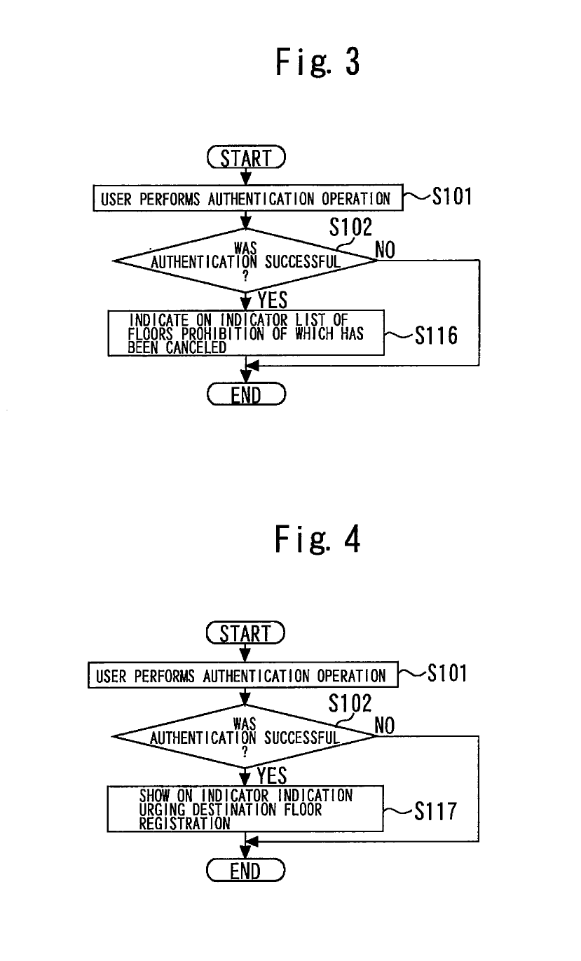

Incidentally, in this embodiment, when personal authentication was performed in S102, prescribed notification may be carried out from a corresponding destination operating panel 1. FIGS. 3 and 4 are flowcharts showing other actions of the elevator group control system in the first embodiment of the present invention and show actions in such a case.

For example, when the authentication was successful in S102, the destination operating panel 1 causes the indicator 7 to indicate a list of prohibited floors whose prohibition of destination floor registration has been canceled (S116). Specifically, when prohibition-canceled floor information is outputted from the prohibited floor control means 9 after S102, the prohibition-canceled floor transmission means 11 transmits the prohibition-canceled floor information to the destination operating panel 1. On the basis of the received prohibition-canceled floor information, the destination operating panel 1 causes the indicator 7 to indicate a list of destination floors whose prohibition of destination floor registration has been canceled.

When the authentication was successful in S102, the destination operating panel 1 causes the indicator 7 to indicate information urging the registration of a destination floor without indicating the name of a specific prohibition-canceled floor (S117). For example, upon receipt of prohibition-canceled floor information from the group controller 3, the destination operating panel 1 causes the indicator 7 to indicate the information to the effect that the prohibition of registration with respect to prohibited floors has been canceled.

### Second Embodiment

In this embodiment, a concrete description will be given of the case where registration floor determination means is provided in the destination operating panel 1.

In this case, the group controller 3 is provided with the prohibited floor storage means 8, the prohibited floor transmission means 13 and the assigned car determination means 12.

The prohibited floor transmission means 13 has the function of transmitting the information on prohibited floors stored in the prohibited floor storage means 8 to each destination operating panel 1.

The destination operating panel 1 is provided with prohibited floor storage means 14, prohibited floor control means 15, prohibition canceling means 16 and registration floor determination means 17 in addition to the numerical keypad 6 and the indicator 7.

The prohibited floor storage means 14 has the function of storing prohibited floors. The prohibited floor storage means 14 stores prohibited floors on the basis of the prohibited floor information received by the destination operating panel 1 from the prohibited floor transmission means 13. That is, the same contents as the storage contents of the prohibited floor storage means 8 are stored in the prohibited floor storage means 14.

The prohibited floor control means 15 has the function of determining the prohibited floor whose prohibition of destination floor registration is to be canceled. When personal authentication has been carried out by the authentication device 2, a successful authentication signal is transmitted from the authentication device 2 to a corresponding destination operating panel 1. Upon receipt of the successful authentication signal by the destination operating panel 1 from the authentication device 2, the prohibition canceling means 16 outputs a request for prohibition cancel to the prohibited floor control means 15. Upon input of the request for prohibition cancel from the prohibition canceling means 16, the prohibited floor control means 15 determines a prohibition-canceled floor on the basis of the prohibited floors stored in the prohibited floor storage means 14. After performing the above-described determination, the prohibited floor control means 15 outputs prohibition-canceled floor information to the registration floor determination means 17.

Incidentally, on the basis of the prohibition-canceled floor information from the prohibited floor control means 15, the actions of FIGS. 3 and 4 may be carried out in the destination operating panel 1.

When a user manually inputs a destination floor by operating the numerical keypad 6 while, for example, making sure of the indication of the indicator 7, the inputted destination floor information is inputted to the registration floor determination means 17.

On the basis of the prohibition-canceled floor information from the prohibited floor control means 15 and the destination floor information from the numerical keypad 6, the registration floor determination means 17 makes a determination as to whether or not the destination floor of the user should be registered.

For example, the registration floor determination means 17 makes a determination as to whether or not the destination floor inputted from the numerical keypad 6 is stored as a prohibited floor in the prohibited floor storage means 14. In the case where the inputted destination floor is stored as a prohibited floor, the registration floor determination means 17 permits the registration only when personal authentication has been carried out by the authentication device 2. In the case where the inputted destination floor has not been stored as a prohibited floor, the registration floor determination means 17 permits the registration if the destination floor can be capable of being served.

Incidentally, after permitting the registration, the registration floor determination means 17 transmits the registered floor information to the group controller 3. On the other hand, when the registration floor determination means 17 does not permit the above-described registration, the registration floor determination means 17 causes the indicator 7 to indicate information to the effect that the registration of the destination floor inputted from the numerical keypad 6 is prohibited and that this floor cannot be registered.

The assigned car determination means 12 has the function of performing car assignment on the basis of the registered floor information from the registration floor determination means 17. That is, the assigned car determination means 12 performs the selection of an assigned car to the destination floor that is inputted by a user from the numerical keypad 6 and whose registration has been permitted by the registration floor determination means 17. After determining an assigned car to the destination floor, the assigned car determination means 12 transmits assignment information to a corresponding car controller 4 and causes the car controller 4 to make a response to the destination floor. After determining an assigned car to the destination floor, the assigned car determination means 12 transmits assignment information to a corresponding destination operating panel 1 and causes the indicator 7 to indicate the information on the assigned car.

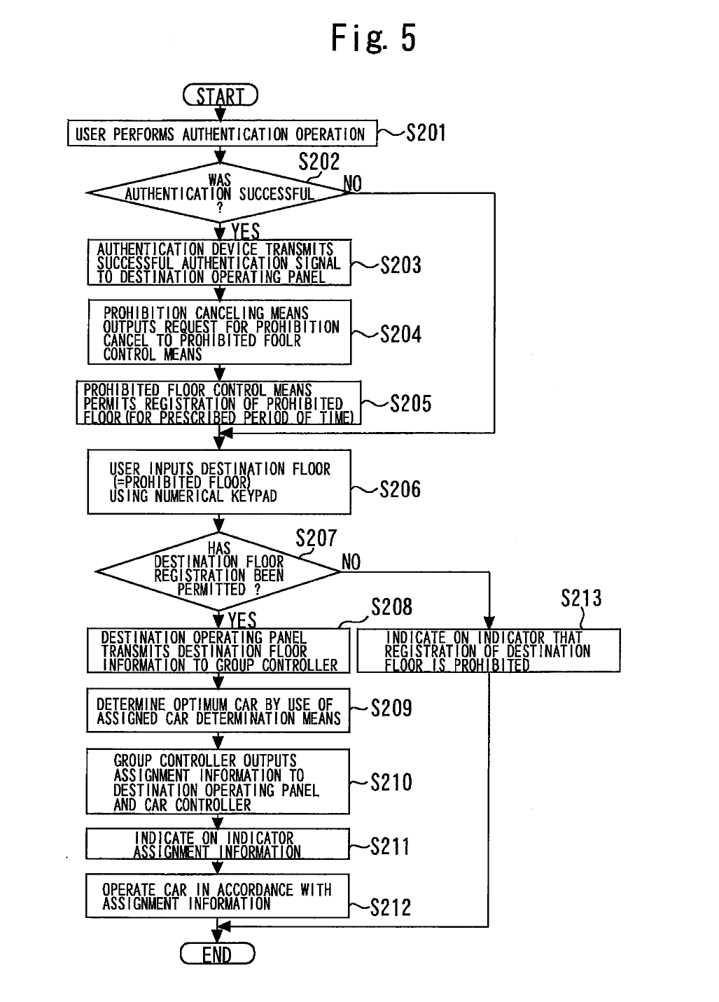

Next, referring to FIG. 5, a concrete description will be given of the actions of the group control system having the above-described configuration. FIG. 5 is a flowchart showing the actions of the elevator group control system in the second embodiment of the present invention.

When an elevator user performs an authentication operation on the authentication device 2 (S201), the authentication device 2 performs personal authentication processing on the basis of inputted personal identification information and makes a determination as to whether or not the authentication was successful (S202). If personal authentication is carried out in S202, the authentication device 2 transmits a successful authentication signal to a corresponding destination operating panel 1 (S203).

In the destination operating panel 1, upon receipt of the successful authentication signal from the authentication device 2, a request for prohibition cancel is outputted from the prohibition canceling means 16 to the prohibited floor control means 15 (S204). Upon input of the request for prohibition cancel from the prohibition canceling means 16, the prohibited floor control means 15 performs processing for permitting registering a prohibited floor as a destination floor for a prescribed period of time (S205). That is, the prohibited floor control means 15 outputs prohibition-canceled floor information to the registration floor determination means 17.

Incidentally, when the user performs the input of a destination floor using the numerical keypad 6 of the destination operating panel 1 (S206), destination floor information is transmitted from the numerical keypad 6 to the registration floor determination means 17, and the registration floor determination means 17 makes a determination as to whether or not the registration of the destination floor has been permitted (S207). In the case where in S206 the user inputted a floor which is stored as a prohibited floor in the prohibited floor storage means 14 as a destination floor, the registration floor determination means 17 determines in S207 that the registration has been permitted only in the case where prohibition-canceled floor information was inputted in S205.

When it is determined in S207 that the registration has been permitted, the information of the registered destination floor is transmitted from the destination operating panel 1 to the group controller 3 (S208). In this case, the assigned car determination means 12 assigns an optimum car to the destination floor of the user (S209). When the assigned car to the destination floor of the user has been determined, the group controller 3 transmits assignment information to the destination operating panel 1 by use of which the user performed the destination floor input in S206 and a corresponding car controller 4 (S210).

Upon receipt of the assignment information from the group controller 3, the destination operating panel 1 causes the indicator 7 to indicate the information on the assigned car, thereby notifying the user (S211). On the basis of the assignment information received from the group controller 3, the car controller 4 appropriately controls the car (S212).

On the other hand, in the case where the personal authentication was unsuccessful in S202 or in the case where an authentication operation on the authentication device 2 was not performed in S201, when in S206 the user inputs a floor stored as a prohibited floor in the prohibited floor storage means 14 as a destination floor, it is determined in S207 that the registration of the floor has not been permitted. In this case, the destination operating panel 1 causes the indicator 7 to indicate information to the effect that the registration of the destination floor inputted by the user is prohibited and that this floor cannot be registered (S213).

Also in the second embodiment of the present invention, it is possible to produce the same effect as in the first embodiment.

### INDUSTRIAL APPLICABILITY

The elevator group control system of the present invention can be applied to an elevator group control system which performs the operation control of a plurality of elevators and in which a user performs destination floor registration before boarding an elevator car.

### REFERENCE SIGNS LIST

1 destination operating panel
2 authentication device
3 group controller
4 car controller
5, 17 registration floor determination means
6 numerical keypad
7 indicator
8, 14 prohibited floor storage means
9, 15 prohibited floor control means
10, 16 prohibition canceling means
11 prohibition-canceled floor transmission means
12 assigned car determination means
13 prohibited floor transmission means

1. An elevator group control system which performs operation control of a plurality of elevators, comprising:
a destination operating panel by use of which a user registers a destination floor by manual operation before boarding an elevator car;
an authentication device which is provided in proximity to the destination operating panel and by use of which a user performs personal authentication by inputting personal identification information;
a registration floor determination device which prohibits destination floor registration from the destination operating panel with respect to a prescribed prohibited floor, and cancels prohibition of destination floor registration with respect to the prohibited floor upon personal authentication by the authentication device; and
a group controller which assigns an optimum car from the plurality of elevators to a destination floor registered from the destination operating panel.

2. The elevator group control system according to claim 1, wherein the registration floor determination device prohibits destination floor registration only for part of floors at which cars of the plurality of elevators stop.

3. The elevator group control system according to claim 1, wherein the registration floor determination device is provided in the group controller.

4. The elevator group control system according to claim 3, wherein
the destination operating panel comprises input device which is permanently installed so as to enable a user to manually input a destination floor;
the group controller comprises prohibited floor storage which stores prohibited floors; and
the registration floor determination device makes a determination as to whether or not a destination floor inputted from the input device is stored as a prohibited floor in the prohibited floor storage and permits registration of a destination floor inputted from the input device only when personal authentication has been carried out by the authentication device in the case where the inputted destination floor is stored as a prohibited floor.

5. The elevator group control system according to claim 1, wherein the registration floor determination device is provided in the destination operating panel.

6. The elevator group control system according to claim 5, wherein
the destination operating panel comprises:
prohibited floor storage which stores prohibited floors; and
an input device which is permanently installed so as to enable a user to manually input a destination floor, and
the registration floor determination device makes a determination as to whether or not a destination floor inputted from the input device is stored as a prohibited floor in the prohibited floor storage and permits registration of a destination floor inputted from the input device only when personal authentication has been carried out by the authentication device in the case where the inputted destination floor is stored as the prohibited floor.

7. The elevator group control system according to claim 1, further comprising:
an indicator provided on the destination operating panel,
wherein upon personal authentication by the authentication device, the destination operating panel causes the indicator to indicate a list of prohibited floors for which prohibition of destination floor registration has been canceled.

8. The elevator group control system according to claim 1, further comprising:
an indicator provided on the destination operating panel,
wherein upon personal authentication by the authentication device, the destination operating panel causes the indicator to indicate information to the effect that prohibition of destination floor registration with respect to prohibited floors has been canceled, and does not perform indication of a specific floor name.
